(19) United States
(12) Patent Application Publication
(10) Pub. No.: US 2005/0122529 A1
(43) Pub. Date: Jun. 9, 2005

(54) Measurement system of three-dimensional shape of transparent thin film using acousto-optic tunable filter

(75) Inventors: Soo Hyun Kim, Daejeon (KR); Dae Suk Kim, Daejeon (KR); Hong Jin Kong, Daejeon (KR); Jang Woo You, Seoul (KR)

Correspondence Address: AKERMAN SENTERFITT, P.O. BOX 3188, WEST PALM BEACH, FL, 33402-3188, US

(73) Assignee: Korea Advanced Institute of Science and Technology, Daejeon (KR)

(21) Appl. No.: 10/729,723

(22) Filed: Dec. 5, 2003

(51) Int. Cl. G01B 9/02

(52) U.S. Cl. 356/503

(57) ABSTRACT

A system for measuring the three-dimensional shape of a transparent thin film using an acousto-optic tunable filter. The system can independently obtain thickness information and shape information about a measurement object having a patterned structure through independent measurements by modes according to whether a blocking plate selectively blocks white light irradiated on a reference mirror plane or not. According to the system for measuring the three-dimensional shape of a transparent thin film using an acousto-optic tunable filter of the present invention, thickness information and shape information about a measurement object including a thin film can be independently measured in two different measurement modes according to whether the blocking plate blocks white light or not, so that three-dimensional shape information of the measurement object can be obtained rapidly.

### BACKGROUND OF THE INVENTION

1. Field of the Invention

The present invention relates to a system for measuring the three-dimensional shape information about a thin film used in a semiconductor fabrication process using an acousto-optic tunable filter. More specifically, the invention relates to a system for measuring the three-dimensional shape of a transparent thin film using an acousto-optic tunable filter (also called “AOTF”) that can independently measure thickness information and shape information of a transparent thin film by employing a combined structure of AOTF capable of scanning a visible spectrum region and a Michelson interferometer module including a blocking plate mounted therein.

2. Background of the Related Art

In general, a semiconductor fabrication process includes a step of forming a transparent thin film on the surface of an opaque metal layer. A conventional white-light scanning interferometer was used as a technique of measuring information about the thickness or shape of the transparent thin film. The white-light scanning interferometer, one of the conventional optical shape measuring systems, is composed of a light source for emitting white light, a beam splitter that is arranged in the direction of emitting the white light to split the white light, and a CCD sensor for obtaining a two dimensional interference image.

The white light emitted from the light source is split by the beam splitter into a reference mirror plane and a measurement object. White light beams reflected from the reference mirror plane and measurement object pass through the beam splitter and are irradiated on the CCD sensor to form an interference image. A piezoelectric element attached to the reference mirror plane is scanned in a straight line, and each point of the 2 dimensional sensor array corresponds to each point of the measurement object.

When the piezoelectric element carries out a scanning operation, a white-light interference signal varying by a distance between the reference mirror plane and the measurement object is generated at the corresponding point of the sensor array. The shape information of the measurement object can be obtained by measuring the correct peak position of the interference signal between the reflected wave from reference plane and that from measured object.

The white-light scanning interferometer adopts the principle of the scanning interferometer using short coherence length of white light and it is used for measuring the three-dimensional shape of an opaque measurement object. In the case where a very thin transparent film is coated on the opaque measurement object, however, lights reflected from the surface of the transparent thin film in addition to wave fronts reflected from the opaque measurement object affect interference. Thus, separation of the lights reflected from the surface of the transparent thin film from the wave fronts from the opaque measurement object becomes a limitation in the actual system.

To solve this, there has been an attempt to obtain a plurality of unknown quantities with respect to thickness information and shape information of a thin film using a numerical-analytical least square fitting method. However, such a method employs the conventional white-light scanning interferometer and requires a very long period of measurement time.

### SUMMARY OF THE INVENTION

Accordingly, the present invention has been made in view of the above problems, the object of the present invention is to provide a system for measuring the three-dimensional shape of a transparent thin film using an acousto-optic tunable filter (AOTF) that can independently obtain thickness information and shape information about a measurement object having a patterned structure through independent measurements by modes according to whether a blocking plate selectively blocks white light irradiated on a reference mirror plane or not.

Another object of the present invention is to provide a system for measuring the three-dimensional shape of a transparent thin film using an AOTF that can scan through visible spectral region without moving any part of the system.

To accomplish the objects, according to the present invention, there is provided a system for measuring the three-dimensional shape of a transparent thin film using an acousto-optic tunable filter, comprising: a light source for emitting white light; a second beam splitter for reflecting and transmitting the white light emitted from the light source to split the white light and irradiate the split white light beams toward a reference mirror plane and a measurement object; a Michelson interferometer module located between the second beam splitter and reference mirror plane, to correspond to a reflection angle of the second beam splitter, the Michelson interferometer module including a blocking plate for selectively blocking the white light beam irradiated on the reference mirror plane; an acousto-optic tunable filter located in the traveling direction of white light selectively reflected from the reference mirror plane according to whether the white light is blocked or not and white light reflected from the measurement object, and adapted to select a monochromatic light beam of a specific wavelength band from the white light irradiated on the surface thereof; a first beam splitter of non-polarized cubic type located to correspond to the projection direction of white light emitted from the light source and the projection direction of white light emitted from the second beam splitter 32, and adapted to allow reflection and transmission of white light to be sequentially carried out among the light source, the second beam splitter and the acousto-optic tunable filter; and a CCD sensor on which the monochromatic light beam selected by the acousto-optic tunable filter is irradiated to form a spectral image.

Preferably, the measurement object is composed of a metal layer with a patterned surface formed on a wafer and a micro-thin film with a patterned surface formed on the metal layer.

The measuring system further includes a single-mode optical fiber one end of which is connected to the light source in the projection direction of white light emitted from the light source and the other end of which is fixed to correspond to a reflection angle of the first beam splitter.

Preferably, the measuring system further includes a first convex lens 13 located between the single-mode optical fiber 11 and the first beam splitter 20 so that light width according to the traveling direction of white light projected from the single-mode optical fiber 11 is aligned before the white light is irradiated to the first beam splitter 20.

It is preferable that the Michelson interferometer module 30 further includes a second convex lens 31 placed between the first and second beam splitters 20 and 32 so as to focus the monochromatic light on the second beam splitter.

Also, the measuring system preferably further includes a third convex lens 50 located between the CCD sensor 70 and the acousto-optic tunable filter 40 so as to focus the selected monochromatic light on the CCD sensor 70.

Preferably, the reference mirror plane 33 is a plane reflection mirror located to correspond to the irradiating direction of the white light.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 illustrates the construction of a shape measuring system according to the present invention;

FIG. 2 illustrates the construction of Michelson interferometer module that operates in a thickness measurement mode according to the present invention;

FIG. 3 illustrates the construction of Michelson interferometer module that operates in a shape measurement mode according to the present invention;

FIG. 4 illustrates the concept of thickness information and shape information according to the present invention;

FIG. 5 is a graph that illustrates the relationship between light intensity and wavelength, measured according to the present invention; and

FIG. 6 illustrates a measurement result with respect to a transparent thin film pattern according to the present invention.

### DETAILED DESCRIPTION OF THE INVENTION

Reference will now be made in detail to the preferred embodiments of the present invention, examples of which are illustrated in the accompanying drawings.

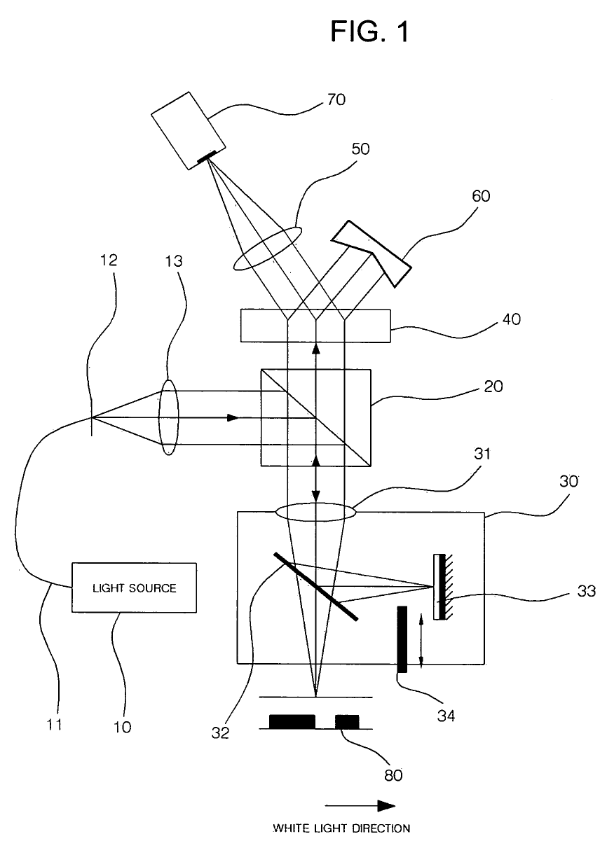

FIG. 1 illustrates the construction of a shape measuring system according to the present invention. As shown in FIG. 1, the shape measuring system 100 applies an acousto-optic tunable filter 40 to a white-light scanning interferometer system to measure a measurement object 80 having a patterned structure composed of an opaque metal layer pattern and a transparent thin film formed on the metal layer pattern using interference of white light beams. In the measurement of the object, the measuring system of the invention measures information about the thickness of the object and information about its shape, independently.

Here, the acousto-optic tunable filter 40, a kind of spectral band-pass filter, is an optical filter that serves as a volume diffraction grating for white light incident on an acousto-optic crystal face. In addition, the acousto-optic tunable filter has a very narrow bandwidth of selecting only a specific wavelength that satisfies a predetermined condition.

A light source 10 that emits white light is a tungsten-halogen lamp with 70 W approximately. One end of a single-mode optical fiber 11 is connected to the light source 10 in the projection direction of the white light to transmit the white light emitted from the light source to the other end of the optical fiber 11.

A fixing member 12 is located at the other end of the optical fiber 11. The other end of the optical fiber 11 is connected to a central pinhole of the fixing member 12. The white light is emitted through the pinhole to spread. A first convex lens 13 is placed in front of the fixing member 12, having a predetermined distance from the fixing member. The white light is aligned in a specific width while passing through the first convex lens 13. The white light that has passed through the first convex lens 13 is inputted to a first beam splitter 20 that is located having a predetermined distance from the first convex lens 13. The first beam splitter 20 has a form of non-polarized cube capable of splitting the white light inputted thereto in the ratio of fifty to fifty. Here, the first beam splitter does not simultaneously split the white light but sequentially splits it according to a measurement procedure.

A reflection angle of the first beam splitter 20 is 45 degrees approximately with respect to white light input direction so that the white light is reflected perpendicularly to its input direction.

A second convex lens 31 is arranged to correspond to the reflection angle of the first beam splitter 20. The second convex lens 31 has a posture contrary to that of the first convex lens 13. That is, the second convex lens 31 focuses the white light on one point according to the traveling direction of the white light while the first convex lens 13 aligns the white light in a specific width. The white light that has passed through the second convex lens 31 is focused on a second beam splitter 32. Here, a portion of the white light that has arrived at the second beam splitter 32 is reflected from the reference mirror plane 33 and the remainder transmits the second beam splitter to be irradiated on the measurement object 80.

A blocking plate 34 is located in front of the reference mirror plane 33, having a predetermined distance from the reference mirror plane. The blocking plate is in close proximity to the reference mirror plane and in parallel with it. The blocking plate selectively blocks the white light inputted to the reference mirror plane 33.

The second convex lens 31, the second beam splitter 32 and the reference mirror plane 33 construct a Michelson interferometer module 30. The Michelson interferometer module further includes the blocking plate 34 to operate in two modes according to whether the blocking plate 34 blocks the white light or not.

The white light beams that has been split by the second beam splitter 32 and inputted to the reference mirror plane 33 and measurement object 80 are subjected to wavelength variation while being irradiated on the measurement object 80. The wavelength variation is caused by shape information and thickness information of the measurement object. The shape information and thickness information can be independently measured in the two modes according to the operation of the blocking plate 34.

The white light that has been irradiated on the measured object is reflected and transmits the second beam splitter 32. The width of the white light is aligned again while passing through the second convex lens 31. Then, the white light passes through the first beam splitter 20 to be inputted to the acousto-optic tunable filter 40 that faces the second convex lens 31, having the first beam splitter 20 between them.

As described above, the acousto-optic tunable filter 40 selectively scans only short waves of a specific band. The acousto-optic tunable filter used in the present invention is non-collinear type having filtering range of 40 nm to 650 nm approximately and resolution of 1 nm to 5.1 nm approximately.

The acousto-optic tunable filter 40 separates only white light having acousto-optic characteristic, that is, white light of a band including thickness information or shape information, from white lights of other bands. This acousto-optic tunable filter 40 is composed of an acousto-optic absorbent, a driving element, and an acousto-optic crystal face on which white light is irradiated. In the case where the white light is inputted to the crystal face, there occurs a variation in the refractive index of the crystal face according to acoustic waves generated by the driving element.

At this time, a moving three-dimensional diffraction grating is formed on the surface of the crystal face so that the irradiated white light collides with the diffraction grating to result in diffraction. Then, the white light is split in parallel so that spectrum images by wavelengths are obtained. When the white light split through the acousto-optic tunable filter 40 is divided into +1 order and −1 order, −1 order is selected and +1 order collides with a blocking member 60 and is absorbed by it to be disappeared.

The CCD sensor 70 has about 752×582 pixels. The size of one pixel is 11.1 μm×11.2 μm.

A third convex lens 50 is located in the traveling direction of the selected white light. The white light that has passed through the third convex lens 50 is focused on the CCD sensor 70 to form an image.

The white light is condensed on the CCD sensor 70 to form a spectral image. The spectral image can be scanned to obtain information. Shape information with respect to the surface of the thin film of the measurement object 80 can be finally obtained using peak information acquired from the obtained information.

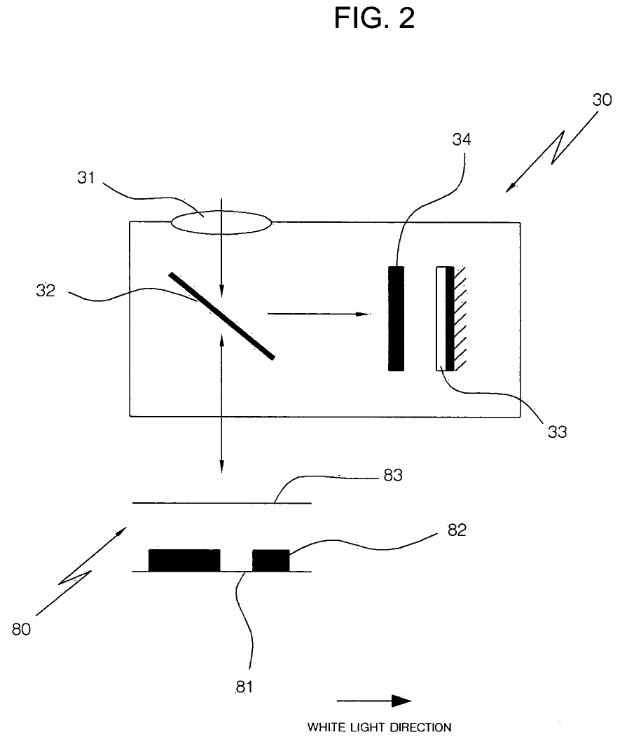

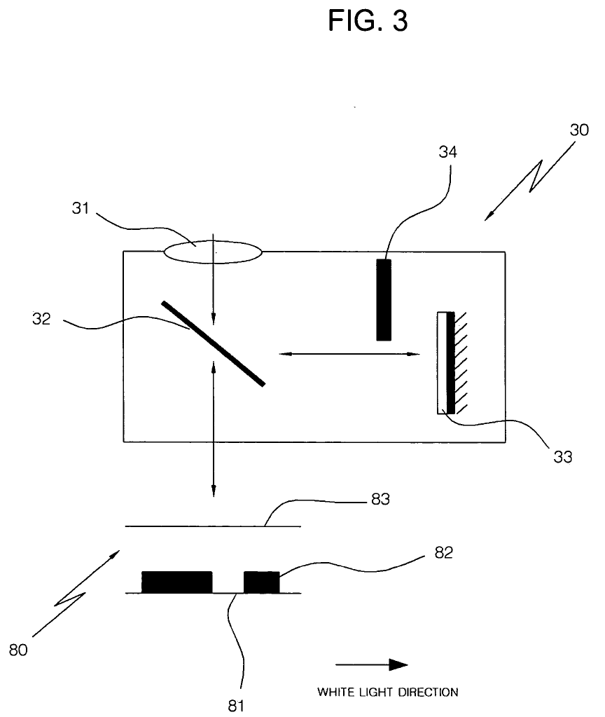

FIG. 2 illustrates the construction of the Michelson interferometer module that operates in a thickness measurement mode according to the present invention, and FIG. 3 illustrates the construction of the Michelson interferometer module that operates in a shape measurement mode according to the present invention.

As shown in FIGS. 2 and 3, the Michelson interferometer module 30 operates in two measurement modes according to whether the blocking plate 34 included therein blocks the white light from being inputted to the measurement object 80 or not, to independently obtain information about the thickness of the measurement object 80 and information about the shape of the pattern formed on the surface of the measurement object 80. The case that measurement is carried out while the white light being blocked by the blocking plate 34 is called a blocking ON mode and the opposite case is called a blocking OFF mode. The information about the thickness of the thin film 83 formed on the measurement object 80 is obtained in such a manner that the Michelson interferometer module 30 operates in the blocking ON mode in which the blocking plate 34 blocks the white light inputted to the reference mirror plane 33.

For this, the Michelson interferometer module 30 includes the blocking plate 34. The blocking plate 34 is located in perpendicular to the traveling direction of the white light inputted to the reference plane 33 while being placed in parallel with the reference mirror plane 33 having a predetermined distance between them.

The Michelson interferometer module 30 operates in the blocking ON mode when the blocking plate 34 moves along its length direction to block the white light inputted to the reference mirror plane 33. Prior to this, a portion of the white light that has inputted into the Michelson interferometer module 30 through the second convex lens 31 passes through the second beam splitter 32 and the remainder is reflected from the second beam splitter.

The blocking plate 34 and reference mirror plane 33 are sequentially located to correspond to the reflection angle of the second beam splitter 32. The blocking plate is movable while the reference plane 33 is fixed.

When the blocking plate 34 blocks the white light, only the white light beam that has passed through the second beam splitter 32 is irradiated on the measurement object 80 that is located in the traveling direction of the white light that has passed through the second beam splitter 32 outside the Michelson interferometer module 30.

The measurement object 80 is constructed in such a manner that a metal layer 82 having a predetermined pattern is formed on a wafer 81 and a thin film 83 is formed thereon. In the blocking ON mode, the white light beam irradiated on the measurement object 80 is reflected to passes through the first beam splitter 20, and then scanned by wavelengths by the acousto-optic tunable filter 40. Then, the white light is inputted to the CCD sensor 70 to be represented as a spectral image from which thickness information can be obtained.

When the blocking plate 34 does not block the white light reflected by the second beam splitter 32, that is, when the Michelson interferometer operates in the blocking OFF mode, the white light is irradiated on the reference mirror plane 33. The reference mirror plane 33 that is a kind of reflection mirror reflects the white light irradiated thereon.

The white light that has passed through the second beam splitter 32 is irradiated on the measurement object 80 and reflected again. The white light reflected from the measurement object 80 reaches the acousto-optic tunable filter 40 together with the white light reflected from the reference mirror plane 33 through transmission and reflection according to the second beam splitter 32 so that scanning by wavelengths is performed.

Light with short wavelength, filtered by wavelengths, is condensed on the CCD sensor 70 and represented as a spectral image. Here, information about the surface of the measurement object 80, that is, the surface of the metal layer 82, can be obtained by interference of wavelengths of white light beams.

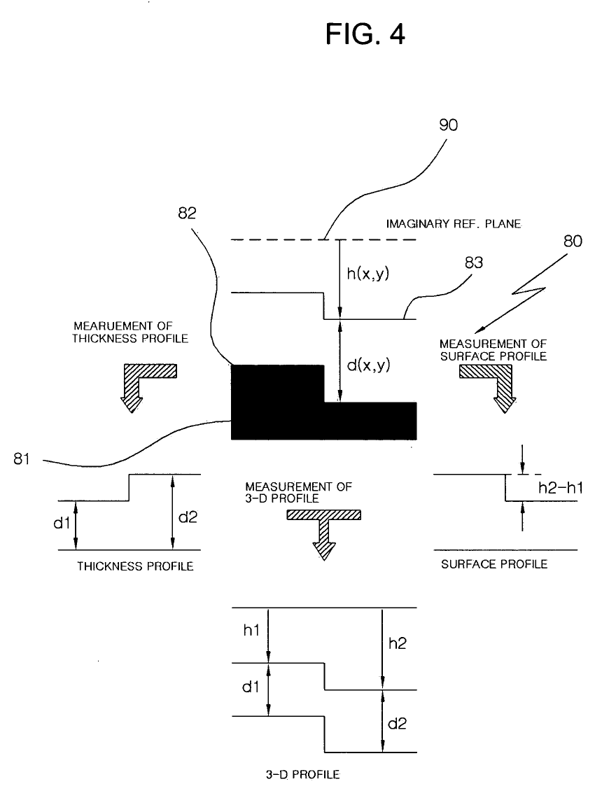

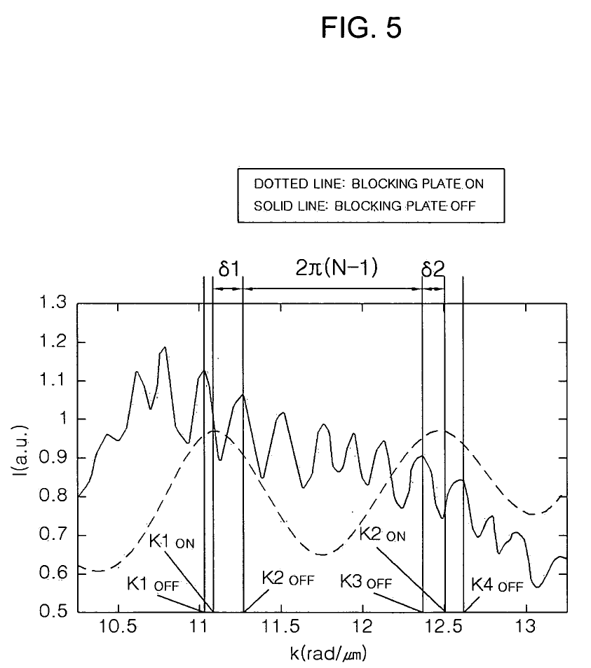

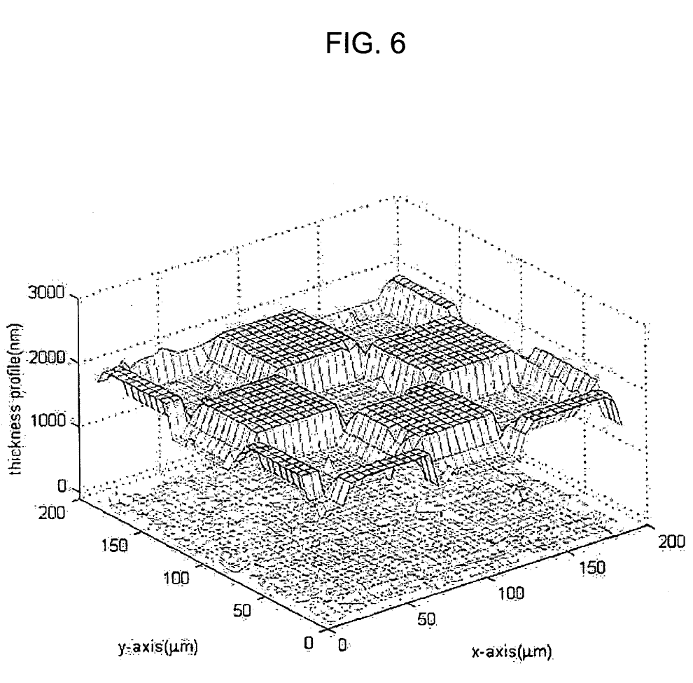

FIG. 4 illustrates the concept of the thickness information and shape information according to the present invention, FIG. 5 is a graph that illustrates the relationship between light intensity and wavelength, measured according to the present invention, and FIG. 6 illustrates a measurement result with respect to a transparent thin film pattern according to the present invention.

Referring to FIGS. 4, 5 and 6, the distance between a imaginary reference mirror plane 90 indicated as a dotted line in FIG. 4 and the surface of the thin film 83 corresponds to two-dimensional surface shape information h(x,y), and the distance between the surface of the thin film 83 and the surface of the metal layer 82 is thickness information d(x,y). Three-dimensional shape information of the thin film 83 can be obtained by extracting peak information of each of the thickness information d and shape information h defined as above.

In the present invention, measurement is carried out in blocking ON mode and OFF mode according to whether the blocking plate 34 blocks the white light or not. The shape information h(x,y) and thickness information d(x,y), obtained independently, are combined to obtain three-dimensional shape information.

FIG. 4 illustrates the measurement object 80 at the center and shows a procedure of measuring the thickness information and shape information at both sides of the measurement object and a procedure of combining the thickness information and shape information into three-dimensional shape information at the lower part.

For measurement of three-dimensional shape information, a phase variation Ψ of the thin film 83 is required. The phase variation with respect to the thin film 83 is needed for obtaining the thickness information d and shape information h. The phase variation remarkably affects the overall phase variation so that phase compensation must be carried out in advance according to following equations.

First of all, interference intensity I of the white light reflected from the reference mirror plane 33 and measurement object 80 is calculated through the following Equation 1.
I(x,y,k,h,d)=|Eᵣ(x, y)+E ₜ(x,y,h)|²=₀(k,d)[1+γ(k,d)cos{2kh+Ψ(k,d,)] (1)

Here, Eᵣ and Eₜ denote wave front functions of light beams reflected from the reference mirror plane 33 and measurement object 80. In addition, k is a propagation constant and uses rad/μm as its unit as shown in FIG. 5.

The following Equation 2 expresses R that is total reflection coefficient of multi-reflected beams according to the thin film 83. This is represented in a complex number and the angle obtained through the complex number indicates a phase variation caused by the thin film 83.

$$R = \frac{{r}_{01} + {r}_{12} exp - j \{ 2 dn ( k ) k \}}{1 + {r}_{01} {r}_{12} exp \{ - j2dn ( k ) k \}} = A + Bj \qquad ( 2 )$$

Here, A denotes the real number part and B represents the imaginary number part. Thus, the phase variation Ψ is calculated by the following Equation 3.
Ψ(k,d)=arctan(B/A) (3)

This phase variation can be represented in the graph shown in FIG. 5 as a measurement result of intensity of white light beam obtained in each mode. In FIG. 5, x-axis denotes propagation constant k(rad/μm) and y-axis represents interference intensity of white light, described in Equation 1. In addition, the dotted line means a measurement result with respect to intensity of white light according to its wavelength in the blocking ON mode, that is, thickness measurement mode, and the solid line indicates a measurement result of intensity of white light with respect to its wavelength in the blocking OFF mode, that is, shape measurement mode. Especially, the distance between neighboring peaks does not exceed 2π in view of the result of interference according to the propagation constant k measured in blocking OFF mode.

The present invention derives that the numerical value of total phase function has periodicity according to periodicity caused by to the phase variation Ψ of the thin film 83 so that, from neighboring two peaks corresponding to one cycle of the phase variation Ψ of the thin film 83, measured in the blocking ON mode, a phase difference of corresponding total phase function can be simply calculated from the propagation constants of the two peaks. Accordingly, the shape information h(x,y) can be obtained considerably approximately.

In the meantime, the thickness information d and shape information h can be calculated through the following Equations 4 and 5. These are calculated on the basis of k(2π/λ) of the peak, as described above. This is possible because the thickness information measured in the thickness measurement mode and the shape information measured in the shape measurement mode respectively include information about the peaks thereof. The thickness information d is finally calculated by the following Equation 4.

$$d = \frac{π}{2 \{ {k}_{1}^{ON} n ( {k}_{1}^{ON} ) - {k}_{2}^{ON} n ( {k}_{2}^{ON} ) \}} \qquad ( 4 )$$

Here, k₁^{ON} and k₂^{ON} correspond to neighboring two peaks obtained in the blocking ON mode, from which the thickness information d is calculated. The shape information h is calculated through the following Equation 5.

$$h = \frac{\{ 2 π ( N - 1 ) + {δ}_{1} + {δ}_{2} \} - \{ Ψ ( {k}_{2}^{ON} ) - Ψ ( {k}_{1}^{ON} ) \}}{2 ( {k}_{2}^{ON} - {k}_{1}^{ON} )} \qquad ( 5 )$$

Here, N means the number of peaks existing between k₁^{ON} and k₂^{ON}, measured in the blocking OFF mode, and δ₁ and δ₂ represent phase compensation terms of the following Equation 6.

$${δ}_{1} = 2 π ( \frac{{k}_{2}^{OFF} - {k}_{1}^{ON}}{{k}_{2}^{OFF} - {k}_{1}^{OFF}} ) \\ {δ}_{2} = 2 π ( \frac{{k}_{2}^{ON} - {k}_{3}^{OFF}}{{k}_{4}^{OFF} - {k}_{3}^{OFF}} ) \qquad ( 6 )$$

Here, k₁^{OFF}, k₂^{OFF}, k₃^{OFF} and ₖ₄^{OFF} correspond to the number of peaks measured in the blocking OFF mode.

The measurement result based on the calculated thickness information d and shape information h is shown in FIG. 6. From FIG. 6, the finally obtained three-dimensional shape can be visually recognized. That is, it can be known that the thickness information d that is the most important factor in the three-dimensional shape of the measurement object 80 can be obtained. The two-dimensional shape of the measurement object can be recognized in x-axis and y-axis directions and the height of the measurement object can be recognized in z-axis direction. Especially, the shape of the metal layer 82, which varies with height, can be definitely recognized.

As described above, the thickness information and shape information can be obtained through the aforementioned measurement and calculation algorithms. Furthermore, the thickness information and shape information can be independently derived through the two measurement modes according to whether the blocking plate 34 blocks white light or not. The measurement algorithm is supported by the construction of the measuring system 100 according to the present invention.

In the three-dimensional shape measuring system 100 using the acousto-optic tunable filter according to the present invention, specifications of the above-described components including the first beam splitter 20 and CCD sensor 70 are merely exemplary and the components can employ various other specifications. In addition, the white light is a kind of light beam close to a specific wavelength and it is an expression described using color vision visually expressed.

According to the system for measuring the three-dimensional shape of a transparent thin film using an acousto-optic tunable filter of the present invention, thickness information and shape information about a measurement object including a thin film can be independently measured in two different measurement modes according to whether the blocking plate blocks white light or not, so that three-dimensional shape information of the measurement object can be obtained rapidly. Furthermore, the measuring system of the present invention can measure the object in real time without driving any part of the system by using the acousto-optic tunable filter so that the measuring system can be applied to a non-destructive measurement for measuring the thickness and shape of a transparent thin film in semiconductor fabrication procedures.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A system for measuring the three-dimensional shape of a transparent thin film using an acousto-optic tunable filter, comprising:
a light source for emitting white light;
a second beam splitter for reflecting and transmitting the white light emitted from the light source to split the white light and irradiate the split monochromatic light beams toward a reference mirror plane and a measurement object;
a Michelson interferometer module located between the second beam splitter and reference mirror plane, to correspond to a reflection angle of the second beam splitter, the Michelson interferometer module including a blocking plate for selectively blocking the white light beam irradiated on the reference mirror plane;
an acousto-optic tunable filter located in the traveling direction of white light selectively reflected from the reference mirror plane according to whether the white light is blocked or not and white light reflected from the measurement object, and adapted to select a monochromatic light beam of a specific wavelength band from the white light irradiated on the surface thereof;
a first beam splitter of non-polarized cubic type located to correspond to the projection direction of white light emitted from the light source and the projection direction of white light emitted from the second beam splitter 32, and adapted to allow reflection and transmission of white light to be sequentially carried out among the light source, the second beam splitter and the acousto-optic tunable filter; and
a CCD sensor on which the monochromatic light beam selected by the acousto-optic tunable filter is irradiated to form a spectral image.

2. The system as claimed in claim 1, wherein the measurement object is composed of a metal layer with a patterned surface formed on a wafer and a thin film with a patterned surface formed on the metal layer.

3. The system as claimed in claim 1, further comprising a single-mode optical fiber one end of which is connected to the light source in the projection direction of white light emitted from the light source and the other end of which is fixed to correspond to a reflection angle of the first beam splitter.

4. The system as claimed in claim 3, further comprising a first convex lens located between the single-mode optical fiber and the first beam splitter so that light width according to the traveling direction of white light projected from the single-mode optical fiber is aligned before the white light is irradiated to the first beam splitter.

5. The system as claimed in claim 1, wherein the Michelson interferometer module further includes a second convex lens placed between the first and second beam splitters so as to focus the white light on the second beam splitter.

6. The system as claimed in claim 1, further comprising a third convex lens located between the CCD sensor and the acousto-optic tunable filter so as to focus the selected monochromatic light on the CCD sensor.

7. The system as claimed in claim 1, wherein the reference mirror plane is a plane reflection mirror located to correspond to the irradiating direction of the white light.
